(19) United States
(12) Patent Application Publication
(10) Pub. No.: US 2013/0107794 A1
(43) Pub. Date: May 2, 2013

(54) NETWORK COMMUNICATION DEVICE AND METHOD OF SELECTING ACTIVE NETWORK INTERFACE

(71) Applicant: Buffalo Inc., Nagoya-shi (JP)

(72) Inventor: Daisuke Yamada, Nagoya-shi (JP)

(73) Assignee: BUFFALO INC., Nagoya-shi (JP)

(21) Appl. No.: 13/658,421

(22) Filed: Oct. 23, 2012

(30) Foreign Application Priority Data
Nov. 2, 2011 (JP) 2011-240859

(51) Int. Cl. H04W 40/00; H04B 7/14

(52) U.S. Cl. 370/315; 370/328

(57) ABSTRACT

A network communication device including a plurality of first network interfaces connected with different networks; a communication controller that controls sending and receiving packets via one of the plurality of first network interfaces; an interface selector that selects, based on a specified first condition, one of the plurality of first network interfaces as a candidate interface for an active network interface; and a switching determiner that determines approval or disapproval of a change of the active network interface from a previously selected network interface to the candidate interface, based on a specified second condition regarding validity of a logical connection via the previously selected network interface, when one of the plurality of first network interfaces different from the previously selected network interface is newly selected as the candidate interface and the previously selected network interface is the current active network interface.

### CROSS-REFERENCE TO RELATED APPLICATIONS

This application claims priority under 35 U.S.C. §119 to Japanese Patent Application No. 2011-240859 filed on Nov. 2, 2011, which is hereby incorporated by reference in its entirety and for all purposes.

### BACKGROUND

1. Technical Field

The disclosure relates to packet sending and receiving technology in a communication network.

2. Related Art

In order to enable the Internet access by a communication terminal, such as a personal computer, a proposed network relay device includes a network interface configured to connect with a communication terminal and a plurality of network interfaces configured to connect to the Internet and selects a working network interface according to a specified condition among the plurality of network interfaces.

The proposed network relay device continually selects the working network interface, based on continually variable information, such as received signal strength indication or communication rate, so that the working network interface may be changed frequently. The working network interface may thus be changed during the user's execution of an application, such as video distribution or sound distribution (streaming), which may cause a trouble, such as sudden interruption of the application.

This problem is not characteristic of the network relay devices but is commonly found in any network communication devices including cell phone devices. For example, in a cell phone device, since the working network interface is continually changed, during execution of an application accompanied with data communication, the application may be interrupted suddenly.

There is accordingly a need, as recognized by the present inventor, to select an adequate network interface, while preventing interruption of communication using a network communication device during a change of the network interface.

### SUMMARY

According to one exemplary embodiment, the disclosure is directed to a network communication device. The network communication device comprises a plurality of first network interfaces connected with different networks; a communication controller that controls sending and receiving packets via one of the plurality of first network interfaces; an interface selector that selects, based on a specified first condition, one of the plurality of first network interfaces as a candidate interface for an active network interface used to send and receive the packets; and a switching determiner that determines approval or disapproval of a change of the active network interface from a previously selected network interface to the candidate interface, based on a specified second condition regarding validity of a logical connection via the previously selected network interface, when one of the plurality of first network interfaces different from the previously selected network interface is newly selected as the candidate interface and the previously selected network interface is the current active network interface.

According to another embodiment, the disclosure is directed to a network communication device. The network communication device comprises a plurality of first network interfaces that are respectively connected with different networks and configured to execute wireless communication or wired communication; a communication controller that controls sending and receiving packets via one of the plurality of first network interfaces; and an interface selector that selects, based on a specified condition, one of the plurality of first network interfaces as a candidate interface for an active network interface that is the first network interface used to send and receive the packets, wherein the communication controller controls sending and receiving the packets without changing the active network interface from a previously selected network interface to the candidate interface in case where a logical connection via the previously selected network interface is valid, while controlling sending and receiving the packets by changing the active network interface from the previously selected network interface to the candidate interface in case where the logical connection is invalid, when one of the plurality of first network interfaces different from the previously selected network interface is newly selected as the candidate interface and the previously selected network interface is the current active network interface.

According to another embodiment, the disclosure is directed to a method of selecting an active network interface that is a first network interface used to send and receive packets in a network communication device that has a plurality of first network interfaces that are respectively connected with different networks and configured to execute wireless communication or wired communication and that uses one of the plurality of first network interfaces to send and receive the packets. The method comprising: selecting, based on a specified first condition, one of the plurality of first network interfaces as a candidate interface for the active network interface; and determining approval or disapproval of a change of the active network interface from a previously selected network interface to the candidate interface, based on a specified second condition regarding validity of a logical connection via the previously selected network interface, when one of the plurality of first network interfaces different from the previously selected network interface is newly selected as a candidate interface and the previously selected network interface is the current active network interface.

### BRIEF DESCRIPTION OF DRAWINGS

FIG. 1 is a block diagram illustrating the configuration of a network relay device as one embodiment of the network communication device of the disclosure;

FIG. 2 schematically illustrates a communication mode using the network relay device;

FIG. 3 illustrates an example of the settings in the SPI-DB shown in FIG. 1;

FIG. 4 illustrates an example of the settings in the address conversion table shown in FIG. 1;

FIG. 5 is a flowchart showing a procedure of relay network interface selecting process performed in the network relay device according to the first embodiment;

FIG. 6 is a flowchart showing a procedure of switching approval/disapproval determination process according to the first embodiment;

FIG. 7 is a block diagram illustrating the configuration of a network relay device according to a second embodiment;

FIG. 8 is a flowchart showing a procedure of switching approval/disapproval determination process according to the second embodiment;

FIG. 9 is a flowchart showing a procedure of switching approval/disapproval determination process according to a third embodiment;

FIG. 10 is a block diagram illustrating the configuration of a cell phone device as one embodiment of the network communication device of the disclosure;

FIG. 11 schematically illustrates a communication mode using the cell phone device according to the fourth embodiment; and

FIG. 12 is a flowchart showing a procedure of working network interface selecting process according to the fourth embodiment.

### DESCRIPTION OF EMBODIMENTS

### A. First Embodiment

A1. Device Configuration

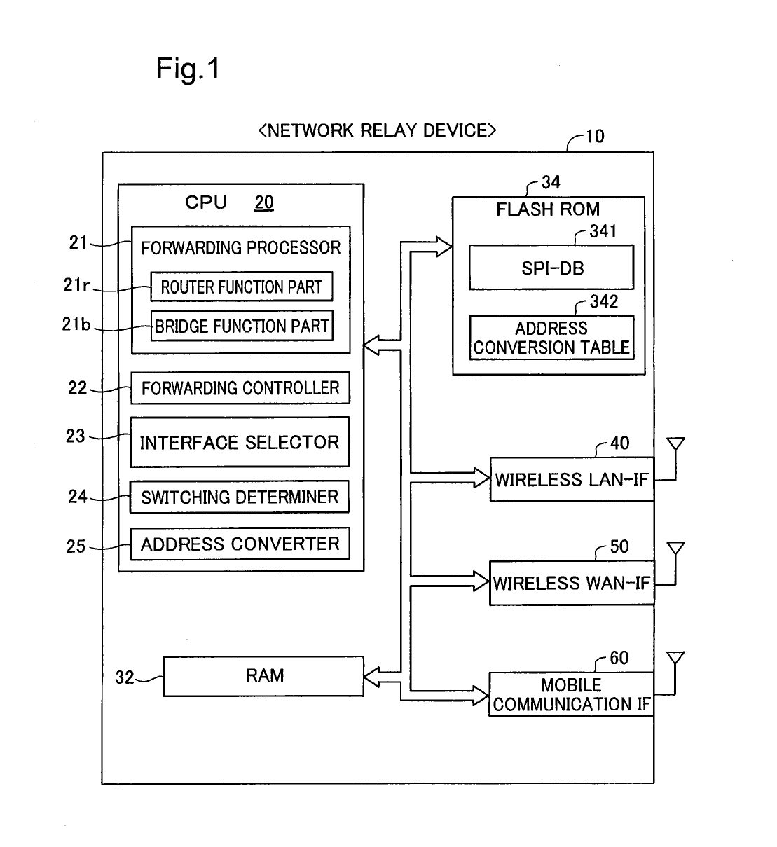

FIG. 1 is a block diagram illustrating the configuration of a network relay device 10 as one embodiment of the network communication device of the disclosure. The network relay device 10 is a mobile router device of high portability and includes a wireless LAN (Local Area Network) interface (hereinafter referred to as “wireless LAN-IF”) 40, a wireless WAN (Wide Area Network) interface (hereinafter referred to as “wireless WAN-IF”) 50, a mobile communication interface (hereinafter referred to as “mobile communication IF”) 60, a CPU (Central Processing Unit) 20, a flash ROM (Read-Only Memory) 34 and a RAM (Random Access Memory) 32. The network relay device 10 serves to connect a wireless LAN client, such as a personal computer or a game machine, to the Internet or to a different wireless LAN from a wireless LAN that the wireless LAN client belongs to.

The wireless LAN-IF 40 includes a modulator, an amplifier and an antenna and works as a wireless LAN access point conforming to, for example, IEEE802.11b/g/n to establish wireless communication with a wireless LAN client (e.g., personal computer or game machine).

The wireless WAN-IF 50 includes a modulator, an amplifier and an antenna and works as a wireless LAN client conforming to, for example, IEEE802.11a/b/g/n to establish wireless communication with a wireless LAN access point (e.g., access point of a public wireless LAN).

The mobile communication IF 60 includes a modulator, an amplifier and an antenna and works as a mobile communication terminal conforming to, for example, 3G/HSPA to establish wireless communication with a wireless base station of a mobile communication network.

As described above, the network relay device 10 of the first embodiment has a plurality of network interfaces to establish wireless communication in respectively different wireless networks.

A group of programs are stored in advance in the flash ROM 34, and the CPU 20 executes the group of programs to serve as a forwarding processor 21, a forwarding controller 22, an interface selector 23, a switching determiner 24 and an address converter 25.

The forwarding processor 21 has a router function part 21r and a bridge function part 21b and works to forward packets input via the respective wireless communication interfaces (wireless LAN-IF 40, wireless WAN-IF 50 and mobile communication IF 60), i.e., layer 3 packets in an OSI (Open Systems Interconnection) reference model and layer 2 frames in the OSI reference model, based on respective destination addresses. The router function part 21r serves to relay layer 3 packets. The bridge function part 21b serves to relay layer 2 frames. The network relay device 10 works as a router device when both the router function part 21r and the bridge function part 21b are enabled, while working as a bridge device when only the bridge function part 21b is enabled.

The forwarding controller 22 controls the forwarding processor 21. More specifically, the forwarding controller 22 can update various tables for routing selection (e.g., routing table and ARP table) used by the forwarding processor 21 to relay packets, an SPI (Stateful Packet Inspection) database (hereinafter referred to as “SPI-DB”) 341 (described later) and an address conversion table 342 (described later).

The interface selector 23 selects one network interface between the wireless WAN-IF 50 and the mobile communication IF 60 as the network interface of the relay destination of a packet received from the wireless LAN-IF 40 (hereinafter referred to as “relay network interface” or “relay network IF”).

When a WAN-side IF (wireless WAN-IF 50 or mobile communication IF 60) is newly selected as the relay network IF, the switching determiner 24 determines approval or disapproval of a change of the relay network IF to the newly selected WAN-side IF.

The address converter 25 converts a local IP address to a global IP address, while converting a global IP address to a local IP address. IP Masquerade (NAPT: Network Address Port Translation) is employed as the system of such address conversion according to this embodiment. A port number on a layer 4 in the OSI reference model is accordingly converted together with the IP address. NAT (Network Address Translation) may be employed in place of IP Masquerade as the system of address conversion.

The SPI-DB 341 and the address conversion table 342 are stored in the flash ROM 34, in addition to the group of programs explained above. The details of the SPI-DB 341 and the address conversion table 342 will be described later.

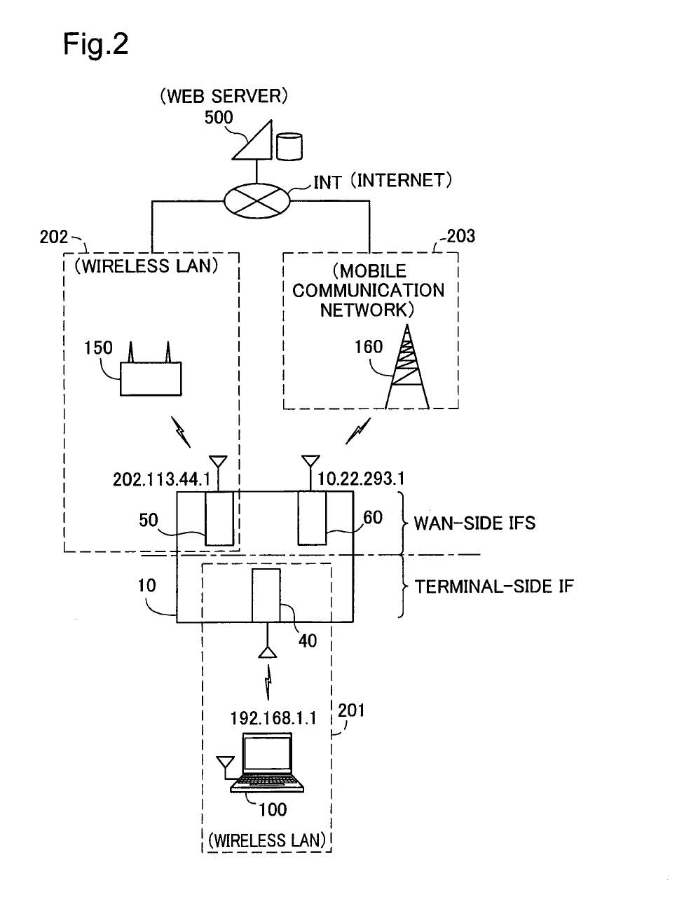

FIG. 2 schematically illustrates a communication mode using the network relay device. In the communication mode of FIG. 2, the personal computer 100 working as a communication terminal and the network relay device 10 are connected with an identical wireless LAN 201. In the wireless LAN 201, the network relay device 10 works as a wireless LAN access point, while the personal computer 100 works as a wireless LAN client. In this mode, the wireless LAN-IF 40 serves as the network interface (terminal-side IF) to establish wireless communication with a wireless terminal.

In the communication mode of FIG. 2, the network relay device 10 and a wireless LAN access point device 150 are connected with an identical wireless LAN 202. In the wireless LAN 202, the network relay device 10 works as a wireless LAN client, while the wireless LAN access point device 150 works as a wireless LAN access point. The network relay device 10 uses its wireless WAN-IF 50 to establish wireless communication with the wireless LAN access point device 150. The wireless LAN 202 is connected to the Internet INT via an ISP (Internet Service Provider) network.

In the communication mode of FIG. 2, the network relay device 10 uses the mobile communication IF 60 to establish wireless communication with a wireless base station 160 in a mobile communication network 203. The mobile communication network 203 is connected to the Internet INT. The network relay device 10 accordingly has the wireless WAN-IF 50 and the mobile communication IF 60 as the network interface used to connect with a network on the Internet INT-side (in other words, different network from the network that the personal computer 100 belongs to) (hereinafter referred to as WAN-side IF).

As shown in FIG. 2, a private IP address “192.168.1.1” is set in the personal computer 100 as the IP (Internet Protocol) address. A global IP address “202.113.44.1” and a global IP address “10.22.293.1” are respectively set in the wireless WAN-IF 50 and in the mobile communication IF 60.

In the communication mode of FIG. 2, the personal computer 100 establishes communication with a device that is connected to the Internet INT (e.g., WEB server 500 shown in FIG. 2) via the wireless LAN 201 and the wireless LAN 202. In this case, the wireless WAN-IF 50 serves as the relay network IF. The personal computer 100 also establishes communication with the device that is connected to the Internet INT (e.g., WEB server 500, via the wireless LAN 201 and the mobile communication network 203. In this case, the mobile communication IF 60 serves as the relay network IF.

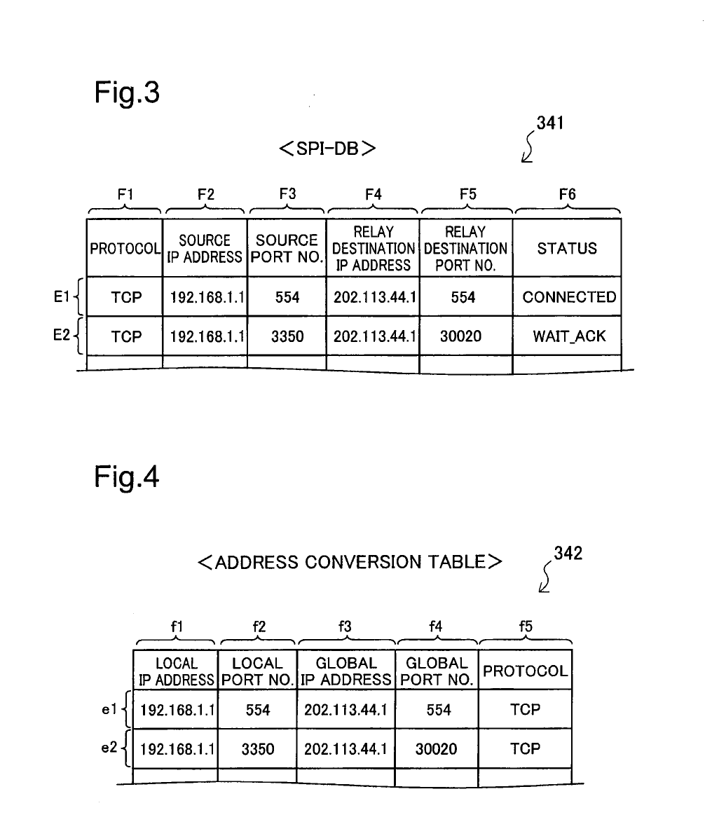

FIG. 3 illustrates an example of the settings in the SPI-DB 341 shown in FIG. 1. Information on identification of a logical connection via the network relay device 10 and information representing the status in the logical connection are recorded in the SPI-DB 341. According to this embodiment, a layer 4 session is employed as the logical connection. As shown in FIG. 3, the SPI-DB 341 includes a first field F1 for recording a layer 4 communication protocol, a second field F2 for recording a source IP address, a third field F3 for recording a source port number in the layer 4, a fourth field F4 for recording a relay destination IP address, a fifth field F5 for recording a relay destination port number in the layer 4 and a sixth field F6 representing the status of the session.

The forwarding controller 22 records a new entry in the SPI-DB 341 on the start of the layer 4 session. More specifically, with respect to a session based on TCP (Transmission Control Protocol) as the layer 4 protocol, a new entry may be recorded in the SPI-DB 341, for example, on transmission of an SYN packet as the start of a known 3-way handshake sequence. The entry may be deleted from the SPI-DB 341, for example, at the end of a termination sequence (transmission and reception of FIN packet and FIN ACK packet). With respect to a session based on UDP (User Datagram Protocol) as the layer 4 protocol, a new entry may be recorded in the SPI-DB 341 on the start of relay of a packet (user data), and the entry may be deleted when no packet is received in a predetermined time period.

In the illustrated example of FIG. 3, two entries (i.e., entries regarding two sessions) are recorded as a first entry E1 and a second entry E2 in the SPI-DB 341. With respect to the first entry E1, “TCP” is set in the first field F1; “192.168.1.1” is set in the second field F2; “554” is set in the third field F3; “202.113.44.1” is set in the fourth field F4; “554” is set in the fifth field F5; and “CONNECTED” is set in the sixth field F6. The first entry E1 accordingly means a session, in which the source is the personal computer 100, the layer 4 communication protocol is TCP, the upper layer protocol is “protocol using a port number 554” (i.e., RTSP (Real Time Streaming Protocol), and the relay destination (relay network IF) of the network relay device 10 is the wireless WAN-IF 50, is in the “CONNECTED” state. The “CONNECTED” state means the state ready for transmission and reception of packets between the personal computer 100 and the WEB server 500 after termination of the 3-way handshake sequence; in other words, the state that a session is established and the session is enabled. The first entry E1 may be recorded, for example, during moving image streaming between the personal computer 100 and the WEB server 500.

With respect to the second entry E2 shown in FIG. 3, “TCP” is set in the first field F1; “192.168.1.1” is set in the second field F2; “3350” is set in the third field F3; “202.113.44.1” is set in the fourth field F4; “30020” is set in the fifth field F5; and “WAIT_ACK” is set in the sixth field F6. The second entry E2 accordingly means a session, in which the source is the personal computer 100, the layer 4 communication protocol is TCP, the upper layer protocol is “protocol using a port number 3350” (i.e., FINDVIATV), the relay destination (relay network IF) of the network relay device 10 is the wireless WAN-IF 50 and the relay destination port number is “30020”, is in the “WAIT_ACK” state. The “WAIT_ACK” state means the state waiting for reception of an ACK packet after transmission of an SYN_ACK packet; in other words, the state that no session has yet been established between the personal computer 100 and the WEB server 500 and the session is not enabled.

FIG. 4 illustrates an example of the settings in the address conversion table 342 shown in FIG. 1. The address conversion table 342 includes a first field f1 for recording a local IP address, a second field f2 for recording a port number in the layer 4 to be used on the local side, a third field f3 for recording a global IP address, a fourth field f4 for recording a port number in the layer 4 to be used on the global side and a fifth field f5 for recording a layer 4 communication protocol.

In the illustrated example of FIG. 4, two entries are recorded as a first entry e1 and a second entry e2 in the address conversion table 342. With respect to the first entry e1, “192.168.1.1” is set in the first field f1; “554” is set in the second field f2; “202.113.44.1” is set in the third field f3; “554” is set in the fourth field f4; and “TCP” is set in the fifth field f5. The first entry e1 accordingly means that a combination (socket) of the local IP address “192.168.1.1” and the port number “554” is converted to a combination (socket) of the global IP address “202.113.44.1” and the port number “554” and that its reverse conversion is performed.

With respect to the second entry e2 shown in FIG. 4, “192.168.1.1” is set in the first field f1; “3350” is set in the second field f2; “202.113.44.1” is set in the third field f3; “30020” is set in the fourth field f4; and “TCP” is set in the fifth field f5. The second entry e2 accordingly means that a combination (socket) of the local IP address “192.168.1.1” and the port number “3350” is converted to a combination (socket) of the global IP address “202.113.44.1” and the port number “30020” and that its reverse conversion is performed.

Each entry is recorded in the address conversion table 342 by the address converter 25 when data is sent from the personal computer 100 to a device connected to the Internet INT. The third field f3 of each entry is updated to an IP address set in an interface selected as the relay network IF (wireless WAN-IF 50 or mobile communication IF 60) by a relay network interface selecting process described below.

The network relay device 10 performs the relay network interface selecting process (described below) to select one of the two network interfaces that are the WAN-side IFs (wireless WAN-IF 50 and mobile communication IF 60) to serve as the relay network IF. This selecting process effectively prevents the session established between the personal computer 100 and the WEB server 500 from being terminated to interrupt an application (for example, moving image streaming).

The network relay device 10 described above is sometimes referred to as the network communication device. The wireless WAN-IF 50 and the mobile communication IF 60 are sometimes described as the plurality of first network interfaces; the relay network interface is sometimes described herein as the active network interface; the wireless LAN-IF 40 is sometimes described herein as the second network interface; the forwarding processor 21 and the forwarding controller 22 are sometimes described herein as the communication processor; and the SPI-DB 341 is sometimes described herein as the communication database.

A2. Relay Network Interface Selecting Process

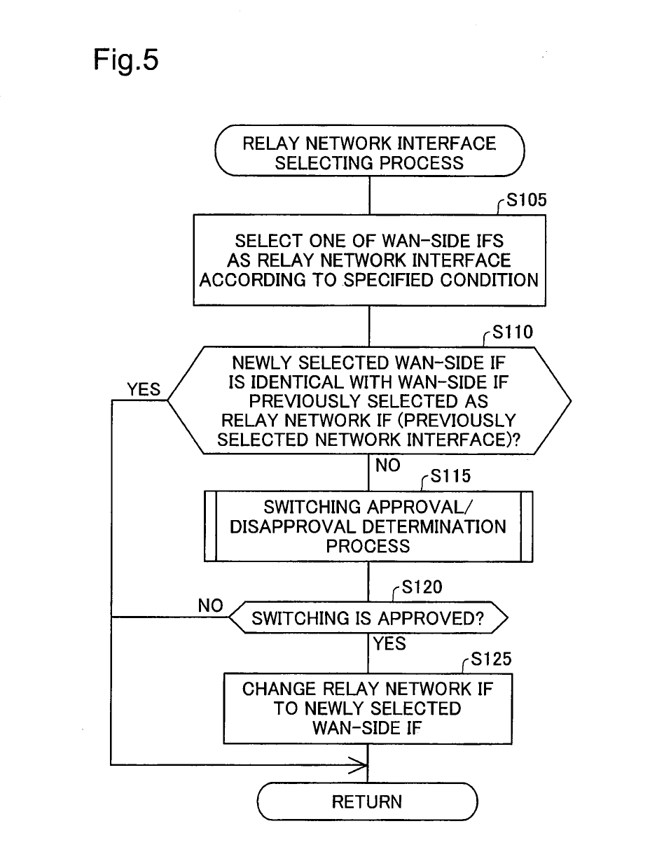

FIG. 5 is a flowchart showing a procedure of relay network interface selecting process performed in the network relay device according to the first embodiment. When the network relay device 10 is powered on, the relay network interface selecting process is performed repeatedly.

The interface selector 23 selects either one of the WAN-side IFs (wireless WAN-IF 50 and mobile communication IF 60) as the relay network IF according to a specified condition (step S105). As described later, the WAN-side IF selected as the relay network IF is actually set as the relay network IF only on determination as switching approved by a switching approval/disapproval determination process, while not being actually set as the relay network IF on determination as switching disapproved by the switching approval/disapproval determination process. “Selecting as the relay network IF” at step S105 is thus expressible as “selecting a candidate for the relay network IF”. The “specified condition” at step S105 may be any suitable condition. For example, the “specified condition” may be the “presence of the WAN-side IF in coverage of signals output from a wireless base station of its corresponding network”. When the network relay device 10 (mobile communication IF 60) is not present in the coverage of the wireless base station of the mobile communication network, this specified condition prevents the mobile communication IF 60 from being selected as the relay network IF. In other words, this specified condition enables the WAN-side IF that enables wireless communication with the wireless base station to be selected as the relay network IF. When the plurality of (both in this embodiment) the WAN-side IFs satisfy this specified condition, a predetermined WAN-side IF may be selected as the relay network IF.

In another example, the “specified condition” may be “the higher received signal strength indication than a predetermined value”. This specified condition prevents the WAN-side IF corresponding to the network having the low received signal strength indication and accordingly having the high possibility of unstable communication from being selected as the relay network IF. In other words, this specified condition enables the WAN-side IF that has the higher received signal strength indication than the predetermined value and enables stable communication to be selected as the relay network IF.

In yet another example, the “specified condition” may be “the highest priority set in advance”. The user may arbitrarily set in advance the priorities to the wireless WAN-IF 50 and the mobile communication IF 60. For example, the user may set the higher priority to the WAN-side IF having the lower communication cost. Such setting enables the WAN-side IF that enables communication with the lower communication cost to be selected as the relay network IF. In another example, the user may set the higher priority to the WAN-side IF having the less power consumption. Such setting enables the WAN-side IF that enables communication with the less power consumption to be selected as the relay network IF.

The “specified condition” may be any arbitrary condition on the communication rate using each WAN-side IF: for example, the “highest average communication rate” or the “highest minimum communication rate”. The “specified condition” at step S105 corresponds to the “specified first condition” and the “specified condition” in the claims.

When selecting the WAN-side IF as the relay network IF at step S105, the switching determiner 24 determines whether the newly selected WAN-side IF is identical with the previously selected WAN-side IF or more specifically the WAN-side IF currently set as the relay network IF (hereinafter referred to as “previously selected network interface”) (step S110). When it is determined that the newly selected WAN-side IF is identical with the previously selected network interface (step S110: YES), the relay network interface selecting process restarts from step S105.

When it is determined that the newly selected WAN-side IF is not identical with the previously selected network interface (step S110: NO), on the other hand, the switching determiner 24 performs the switching approval/disapproval determination process (step S115). In the first cycle of this process after power-on, there is no previously selected network interface, so that it is determined as “not identical” at step S110.

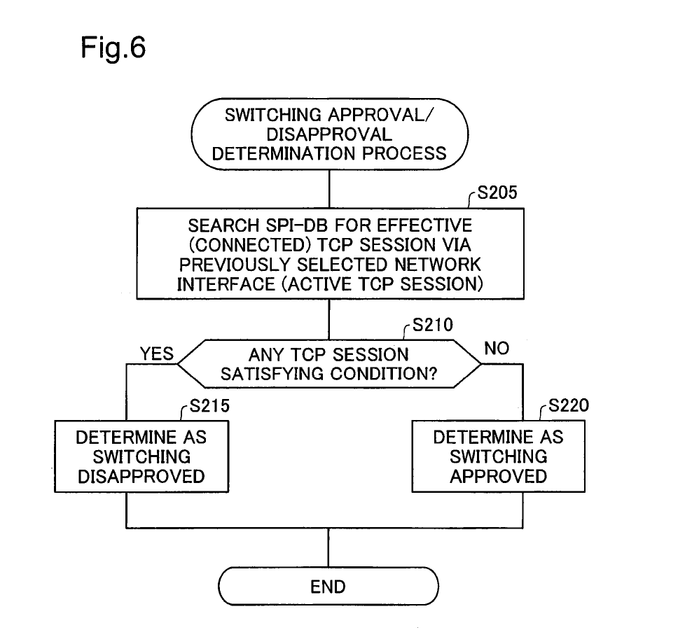

FIG. 6 is a flowchart showing a procedure of switching approval/disapproval determination process according to the first embodiment. The switching determiner 24 searches the SPI-DB 341 for any effective TCP session via the previously selected network interface (hereinafter referred to as “active TCP session”) (step S205) and determines whether any TCP session satisfying the condition is present or absent (step S210). According to this embodiment, the effective TCP session means the TCP session in the “CONNECTED” state. For example, when the previously selected network interface is the wireless WAN-IF 50, the SPI-DB 341 is searched for any entry having the registries of “TCP” in the first field F1, “202.113.44.1” in the fourth field and “CONNECTED” in the sixth field F6. As the result of this search, the first entry E1 shown in FIG. 3 is found, and it is determined that “any TCP session satisfying the conditions is present”.

On determination that “any TCP session satisfying the condition is present” at step S210, the switching determiner 24 determines that switching the relay network IF to the newly selected WAN-side IF is disapproved (step S215). On determination that “no TCP session satisfying the condition is present” at step S210, on the other hand, the switching determiner 24 determines that switching the relay network IF to the newly selected WAN-side IF is approved (step S220).

Referring back to FIG. 5, when it is determined that switching is approved (step S120: YES) as the result of the switching approval/disapproval determination process (step S115), the forwarding controller 22 registers the newly selected WAN-side IF in a routing table and changes the relay network IF from the previously selected network interface to the newly selected WAN-side IF (step S125). As a result, the newly selected WAN-side IF (wireless WAN-IF 50 or mobile communication IF 60) is used for communication between the personal computer 100 and the device connected to the Internet INT. The forwarding controller 22 also registers the IP address of the newly selected WAN-side IF into the SPI-DB 341 and the address conversion table 342.

When it is determined that switching is disapproved (step S120: NO) as the result of step S115, the relay network interface selecting process restarts from step S105. As a result, the routing table is not updated, and the relay network IF is kept to the previously selected network interface. The “presence or absence of the active TCP session” of this embodiment corresponds to the specified second condition in the claims.

The following describes a concrete operation of the relay network interface selecting process. For example, in the state that the wireless WAN-IF 50 is currently set as the relay network IF, when the mobile communication IF 60 is selected as the new (candidate of) relay network IF at step S105, the session of the first entry E1 shown in FIG. 3 is found at step S205 in the switching approval/disapproval determination process. In this case, since it is determined that switching is disapproved at step S215, the relay network interface selecting process restarts from step S105 without changing the relay network IF from the wireless WAN-IF 50 to the mobile communication IF 60. This does not interrupt the application (e.g., moving image streaming) executed by the session of the first entry E1 shown in FIG. 3.

When the application is completed and the session of the first entry E1 shown in FIG. 3 is terminated, no active TCP session is found in the SPI-DB 341 as the result of step S205 in the switching approval/disapproval determination process. In this case, it is determined that switching is approved at step S220, so that the relay network IF is changed to the mobile communication IF 60 at step S125. Since the application executed on the upper layer has already been completed, there is no interruption of the application accompanied with the change of the relay network IF. Changing the relay network IF enables the interface satisfying the “specified condition” at step S105 to work as the relay network IF.

As described above, the network relay device 10 of the first embodiment checks the presence or the absence of any active TCP session that is the effective TCP session via the previously selected network interface (i.e., the TCP session in the “CONNECTED” state) and does not change the relay network IF from the previously selected network interface to the newly selected WAN-side IF when there is any active TCP session. The network relay device 10 of the first embodiment can thus prevent interruption of communication via the network relay device 10 accompanied with the change of the relay network IF. When there is no active TCP session, on the other hand, the relay network IF is changed from the previously selected network interface to the newly selected WAN-side IF. This enables the relay network IF to be changed to the adequate WAN-side IF satisfying the specified condition. The network relay device 10 of the first embodiment repeatedly performs the relay network interface selecting process and thereby enables the relay network IF to be changed to the WAN-side IF satisfying the specified condition at step S105 after termination of the active TCP session.

### B. Second Embodiment

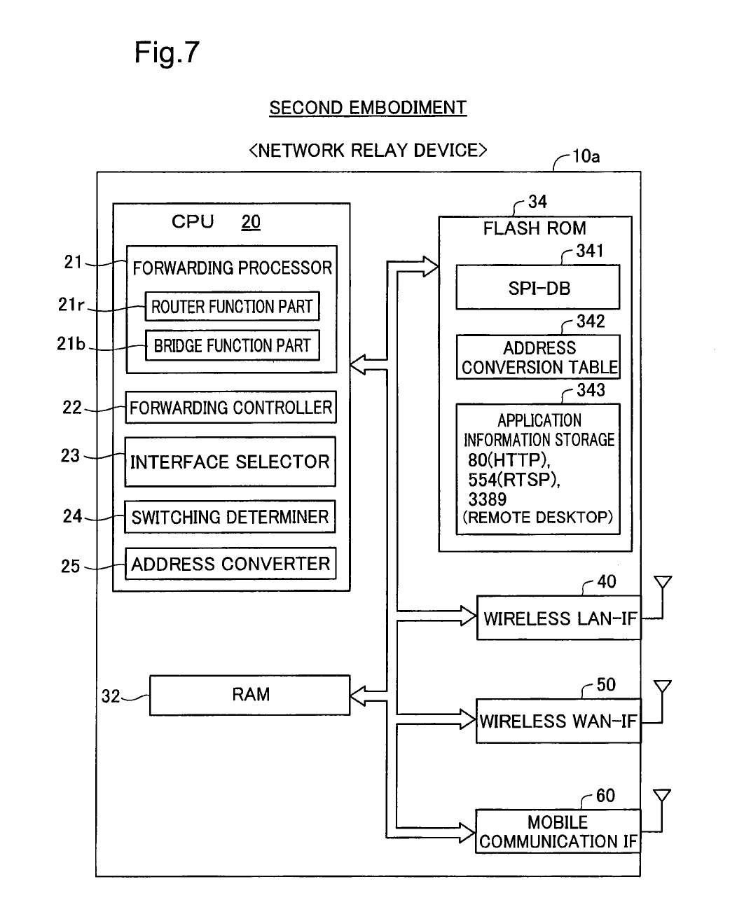

FIG. 7 is a block diagram illustrating the configuration of a network relay device 10a according to a second embodiment. The network relay device 10a of the second embodiment differs from the network relay device 10 of the first embodiment shown in FIG. 1 by an application information storage 343 provided in the flash ROM 34, but the other configuration is substantially the same as the configuration of the first embodiment.

Port numbers in the layer 4 corresponding to the user's specified application (i.e., protocol in the fifth layer (layer 5) or the higher layer in the OSI reference model) are stored in the application information storage 343. According to this embodiment, as illustrated in FIG. 7, port numbers corresponding to the protocol used for moving image streaming have been stored in advance in the application information storage 343 by the user. More specifically, a port number “80” (HTTP: HyperText Transfer Protocol), a port number “554” (RTSP) and a port number “3389” (remote desktop) are stored in advance in the application information storage 343.

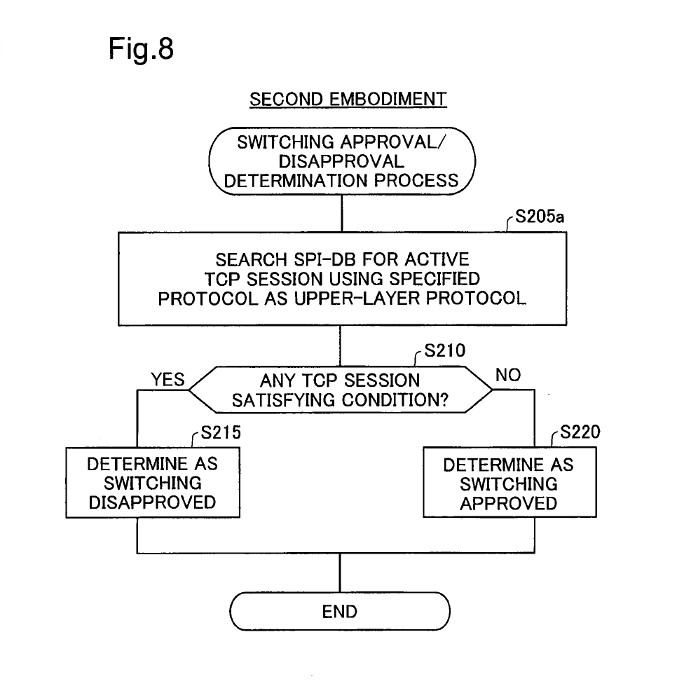

FIG. 8 is a flowchart showing a procedure of switching approval/disapproval determination process according to the second embodiment. The switching approval/disapproval determination process of the second embodiment differs from the switching approval/disapproval determination process of the first embodiment shown in FIG. 6 by replacement of step S205 with step S205a, but is otherwise the same as the first embodiment.

The switching determiner 24 searches the SPI-DB 341 for any active TCP session using the user's specified protocol as the upper layer protocol (step S205a). When the registry in the third field F3 in the SPI-DB 341 matches with any port number stored in the application information storage 343, the switching determiner 24 identifies that the upper layer protocol is the user's specified protocol. For example, when the previously selected network interface is the wireless WAN-IF 50, the SPI-DB 341 is searched for any entry having the registries of “TCP” in the first field F1, “202.113.44.1” in the fourth field F4, “CONNECTED” in the sixth field F6 and any one of “80”, “554” and “3389” in the third field F3. As the result of this search, the first entry E1 shown in FIG. 3 is found.

After completion of step S205a, the processing of steps S210 to S220 is performed as described above. The procedure of the second embodiment determines that switching is approved (step S220) when there is no active TCP session, like the first embodiment. Even in the presence of any active TCP session, when the upper layer protocol used by the active session is not the user's specified protocol, the procedure of the second embodiment determines that switching is approved (step S220). As a result, the relay network IF is changed from the previously selected network interface to the newly selected WAN-side IF. When there is any active TCP session using the user's specified protocol as the upper layer protocol, on the other hand, the relay network IF is not changed to the newly selected WAN-side IF. There is accordingly no change of the relay network IF during the user's execution of the application, for example, moving image streaming based on HTTP, in the personal computer 100. This application is thus performed without interruption.

As clearly understood from the above example, interruption of the application accompanied with the change of the relay network IF can be avoided by the user's advance storage of the port number corresponding to the application that should not be interrupted by the change of the relay network IF, in the application information storage 343.

As described above, even in the presence of any active TCP session, when the upper layer protocol used by this session is not the user's specified protocol, the relay network IF is changed. This is attributed to the assumption that the user determines that there is no substantial problem caused by interruption of the application using a different protocol from the user's specified protocol. The network relay device 10a of the second embodiment having such configuration changes the relay network IF during execution of the application corresponding to a different port number from any of the port numbers stored in the application information storage 343 (i.e., application that is allowed to be interrupted by the user), thus enabling communication using the adequate WAN-side IF satisfying the specified condition. The network relay device 10a of the second embodiment does not change the relay network IF during execution of the application corresponding to any of the port numbers stored in the application information storage 343 (i.e., application that is not allowed to be interrupted by the user), thus preventing interruption of the application based on the user's intention.

The network relay device 10a of the second embodiment described above has the similar advantageous effects to those of the network relay device 10 of the first embodiment. Additionally, the network relay device 10a of the second embodiment does not change the relay network IF when there is any active TCP session using the user's specified protocol as the upper layer protocol. This effectively prevents interruption of the application using the user's specified protocol as the upper layer protocol. Furthermore, the network relay device 10a of the second embodiment changes the relay network IF when there is any active TCP session using a different protocol from the user's specified protocol as the upper layer protocol. This enables communication using the adequate WAN-side IF satisfying the specified condition. The network relay device 10a of the second embodiment refers to the port numbers stored in the application information storage 343 and determines whether the active TCP session is the switchable session. The user can thus control determination whether switching of the session is approved or disapproved by adjusting the port numbers stored in the application information storage 343.

### C. Third Embodiment

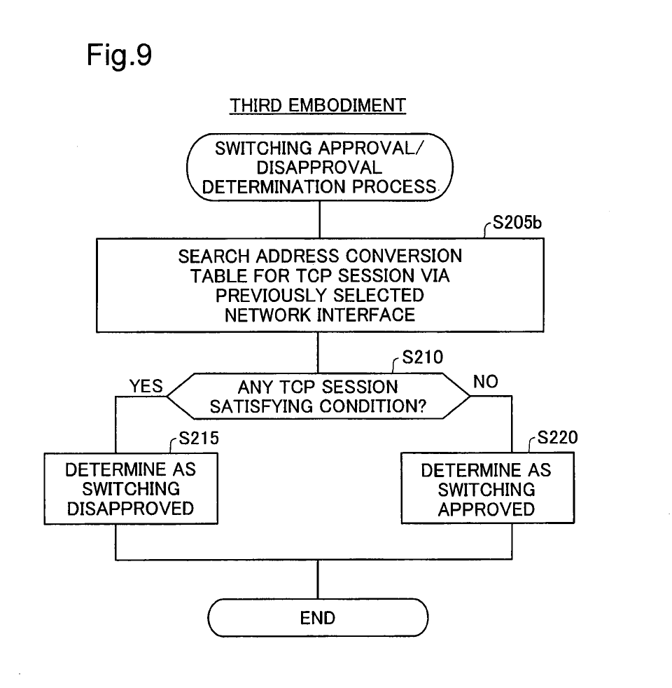

FIG. 9 is a flowchart showing a procedure of switching approval/disapproval determination process according to a third embodiment. A network relay device of the third embodiment differs from the network relay device 10 of the first embodiment by replacement of step S205 with step S205b in the switching approval/disapproval determination process, but the other configuration (device configuration and the other steps of the switching approval/disapproval determination process) is substantially the same as the first embodiment.

In the switching approval/disapproval determination process performed in the network relay device of the third embodiment, the switching determiner 24 searches the address conversion table 342 for any TCP session via the previously selected network interface (step S205b) and subsequently performs the processing of step S210 described above. For example, when the WAN-side IF newly selected at step S105 is the wireless WAN-IF 50, the address conversion table 342 is searched for any entry having the registry of “TCP” in the fifth field f5. As a result, the first entry e1 and the second entry e2 shown in FIG. 4 are found, so that it is determined that “there is any TCP session via the previously selected network interface”. After step S210, either step S215 or step S220 is performed according to the result of the determination.

The network relay device of the third embodiment described above has the similar advantageous effects to those of the first embodiment. The approval or disapproval of switching is readily determinable, based on the presence or the absence of any session having the registry of “TCP” in the fifth field f5 in the address conversion table 342. This shortens the time period required for the switching approval/disapproval determination process and reduces the processing load of the CPU 20. The address conversion table 342 of the third embodiment corresponding to the communication database in the claims.

As clearly understood from the first to the third embodiments described above, the approval or disapproval of switching the relay network IF is determinable, based on any arbitrary condition about the presence or the absence of any effective TCP session via the WAN-side IF previously selected as the relay network IF (i.e., validity of TCP session).

### D. Fourth Embodiment

The above first to the third embodiments describe application of the network communication device to the network relay device (mobile router), but a fourth embodiment describes application of the network communication device to a cell phone device.

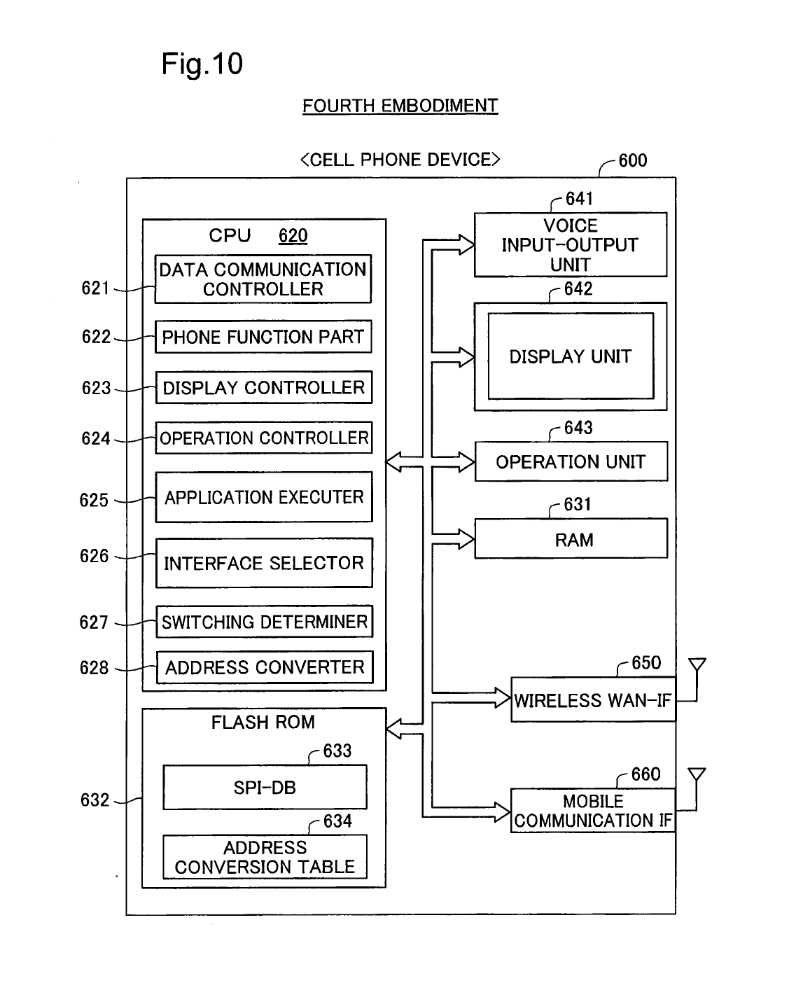

FIG. 10 is a block diagram illustrating the configuration of a cell phone device 600 as one embodiment of the network communication device of the disclosure. The cell phone device 600 includes a wireless WAN-IF 650, a mobile communication IF 660, a CPU 620, a flash ROM 632, a RAM 631, a voice input-output unit 641, a display unit 642 and an operation unit 643. The cell phone device 600 can serve as a conventional telephone set to establish voice communication with another telephone set and also serve as a data communication terminal to establish data communication with, e.g., a device connected to the Internet.

The CPU 620 of the fourth embodiment differs from the CPU 20 of the first embodiment by the functions as a data communication controller 621, a phone function part 622, a display controller 623, an operation controller 624 and an application executer 625, in place of the forwarding processor 21 and the forwarding controller 22.

The data communication controller 621 controls data communication established via a network by the cell phone device 600. For example, when an application executed by the cell phone device 600 is accompanied with TCP/IP (Transmission Control Protocol/Internet Protocol) communication between the cell phone device 600 and a device connected therewith via a network, the data communication controller 62 performs TCP/IP operations. More specifically, the data communication controller 621 sends and receives layer 3 packets according to a routing table stored in the flash ROM 632. The data communication controller 621 of the fourth embodiment corresponds to the communication processor in the claims.

The phone function part 622 performs various operations to enable the phone functions, such as call connection, call clearing, voice encoding and denoising. The display controller 623 controls the image display (e.g., displaying a WEB page obtained by application execution) on the display unit 642. The operation controller 624 interprets input information from the operation unit 643 and transmits the results of interpretation to the other function parts 621 to 623 and 625. The application executer 625 executes an application according to application software stored in the flash ROM 632.

The CPU 620 of the fourth embodiment works as the respective function parts 621 to 625 described above and further serves as an interface selector 626, a switching determiner 627 and an address converter 628. The interface selector 626 of the fourth embodiment has the same functions as those of the interface selector 23 of the first embodiment and is thus not specifically described here. Similarly, the switching determiner 627 and the address converter 628 of the fourth embodiment respectively have the same functions as those of the switching determiner 24 and the address converter 25 of the first embodiment and are thus not specifically described here.

The voice input-output unit 641 includes a microphone and a speaker and serves to generate a voice signal based on the input voice and reproduce the voice based on the voice signal. The display unit 642 displays an operation menu screen and a still image or a moving image obtained as the result of application execution. The display unit 642 may be, for example, a touch-panel liquid crystal display. The operation unit 643 has various operation buttons, e.g., buttons operable to adjust the sound volume and buttons operable to move the cursor position on the display unit 642.

The wireless WAN-IF 650 of the fourth embodiment has the same functions as those of the wireless WAN-IF 50 of the first embodiment and is thus not specifically described here. Similarly, the mobile communication IF 660, the RAM 631 and the flash ROM 632 respectively have the same functions as those of the mobile communication IF 60, the RAM 32, and the flash ROM 34 of the first embodiment and are thus not specifically described here. An SPI-DB 633 and an address conversion table 634 of the fourth embodiment are respectively the same as the SPI-DB 341 and the address conversion table 342 of the first embodiment and are thus not specifically described here.

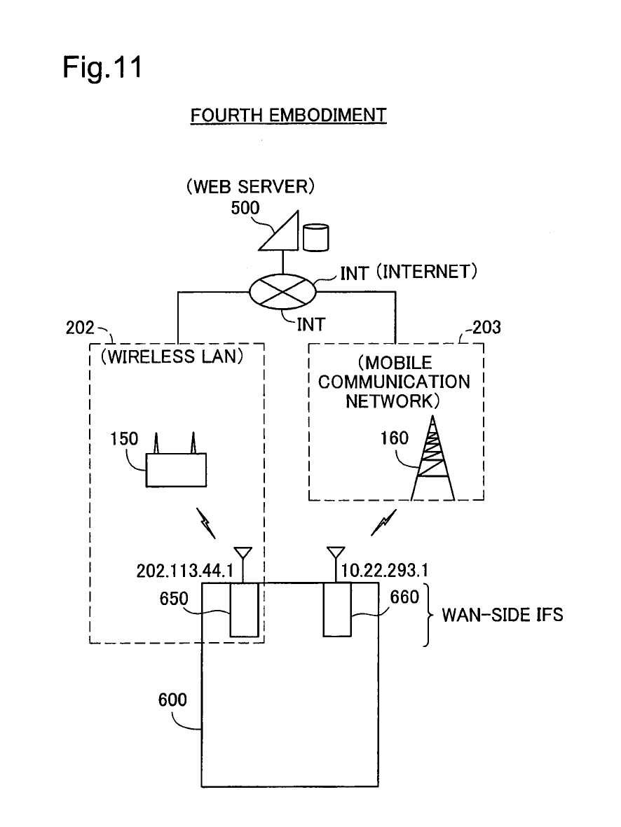

FIG. 11 schematically illustrates a communication mode using the cell phone device according to the fourth embodiment. The communication mode of FIG. 11 differs from the communication mode of the first embodiment shown in FIG. 2 by the absence of the structure to be connected with a communication terminal, but the other structures in the communication mode are substantially similar to those in the communication mode of the first embodiment. More specifically, the cell phone device 600 does not have a terminal-side IF and does not relay data (packets) received from another communication terminal (e.g., personal computer 100 in the first embodiment) separate from the cell phone device 600 or data (packets) addressed to another communication terminal. The cell phone device 600 executes a similar application to the application executed by the personal computer 100 of the first embodiment. When this application is accompanied with communication, the cell phone device 600 uses either of the wireless WAN-IF 650 and the mobile communication IF 660 that are both WAN-side IFs (interfaces used for connection with a network) to send and receive packets.

The cell phone device 600 of the fourth embodiment performs a working network interface selecting process (described below) to select a network interface used for transmission and reception of packets (hereinafter referred to as “working network interface” or “working network IF”) between the two WAN-side IFs (wireless WAN-IF 650 and mobile communication IF 660), thereby preventing interruption of communication accompanied with change of the working network IF and enabling the change of the relay network IF to the adequate WAN-side IF satisfying a specified condition.

The cell phone device 600 of this embodiment corresponds to the network communication device in the claims. The data communication controller 621 corresponds to the communication processor in the claims.

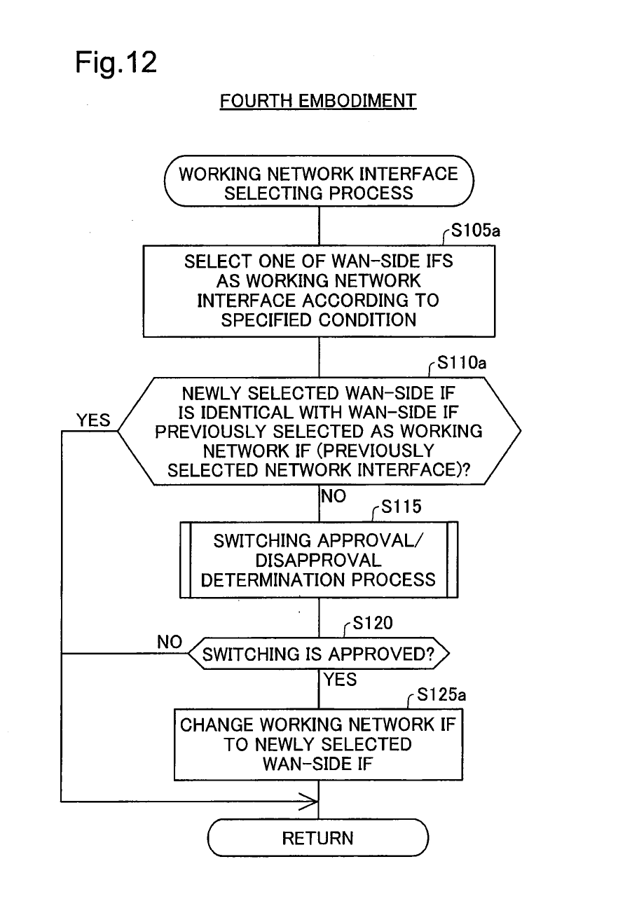

FIG. 12 is a flowchart showing a procedure of working network interface selecting process according to the fourth embodiment. The working network interface selecting process of the fourth embodiment differs from the relay network interface selecting process of the first embodiment shown in FIG. 5 by replacement of step S105 with step S105a, replacement of step S110 with step S110a and replacement of step S125 with step S125a, but the other configuration is the same as the relay network interface selecting process of the first embodiment.

The interface selector 626 selects either one of the two WAN-side IFs (wireless WAN-IF 650 and mobile communication IF 660) as the working network IF according to a specified condition (step S105a). The details of the specified condition are those described in the first embodiment. Like the first embodiment, “selecting the working network IF” at step S105a is expressible as “selecting a candidate for the working network IF”.

When selecting the WAN-side IF as the working network IF at step S105a, the switching determiner 627 determines whether the newly selected WAN-side IF is identical with the previously selected network interface (WAN-side IF previously selected as the working network IF or more specifically WAN-side IF currently set as the working network IF according to this embodiment) (step S110a). When it is determined that the newly selected WAN-side IF is identical with the previously selected network interface (step S110a: YES), the working network interface selecting process restarts from step S105a. When it is determined that the newly selected WAN-side IF is not identical with the previously selected network interface (step S110a: NO), on the other hand, the processing of steps S115 and S120 is performed as described above.

When it is determined that switching is approved (step S120: YES) as the result of the switching approval/disapproval determination process (step S115), the data communication controller 621 registers the newly selected WAN-side IF in a routing table and changes the working network IF from the previously selected network interface to the newly selected WAN-side IF (step S125a). As a result, the newly selected WAN-side IF (wireless WAN-IF 650 or mobile communication IF 660) is used for communication between the cell phone device 600 and a device connected to the Internet INT (e.g., WEB server 500). The data communication controller 621 also registers the IP address of the newly selected WAN-side IF into the SPI-DB 633 and the address conversion table 634.

The cell phone device 600 of the fourth embodiment described above has the similar advantageous effects to those of the network relay device 10 of the first embodiment. The cell phone device 600 of the fourth embodiment effectively prevents interruption of communication using the TCP session accompanied with the change of the working network IF, while enabling the working network IF to be changed to the adequate WAN-side IF satisfying the specified condition. Additionally, the cell phone device 600 of the fourth embodiment repeatedly performs the working network interface selecting process and thereby enables the working network IF to be changed to the WAN-side IF satisfying the specified condition at step S105a after termination of the active TCP session.

### E. Modifications

The disclosure is not limited to the above embodiments but various modifications and variations may be made to the embodiments without departing from the scope of the disclosure. For example, some of these embodiments may be combined according to the requirements, and some examples of possible modification are given below.

E1. Modification 1

The switching approval/disapproval determination process of the above embodiments performs the step of determining that switching is approved (step S220) or the step of determining that switching is disapproved (step S215), but these steps may be omitted. For example, when it is determined at step S210 shown in FIG. 6 that there is any TCP session satisfying the condition, the relay network interface selecting process may restart from step S105 without performing the processing of step S215. When it is determined at step S210 that there is no TCP session satisfying the condition, on the other hand, the relay network interface selecting process may perform the processing of step S125 shown in FIG. 5.

E2. Modification 2

The switching approval/disapproval determination process of the above embodiments determines whether switching is approved or disapproved, based on the presence or the absence of any effective TCP session, but the disclosure is not limited to this procedure. For example, the approval or disapproval of switching may be determined, based on the presence or the absence of any effective UDP session, in place of or in addition to based on the presence or the absence of any effective TCP session. More specifically, the approval or disapproval of switching may be determined, based on the presence or the absence of any UDP session via the previously selected network interface that is set in the “ASSURED” state. In other words, the approval or disapproval of switching is determinable, based on the validity of any layer 4 session via the previously selected network interface. In another example, the approval or disapproval of switching may be determined, based on the validity of a session (logical connection) in the layer 5 or the upper layer, in place of or in addition to the session in the layer 4, such as TCP or UDP. For example, in the cell phone device 600 of the fourth embodiment, the application executer 625 may identify the validity of the session in the upper layer, and the switching determiner 627 may determine whether switching is approved or disapproved, based on the identified validity. In general, it is determinable whether switching the relay network IF or the working network IF is approved or disapproved, based on any arbitrary condition regarding the validity of a logical connection via the previously selected network interface.

E3. Modification 3

In the first to the third embodiments, the relay network interface selecting process is performed repeatedly when the network relay device 10 or 10a is powered on. In the fourth embodiment, the working network interface selecting process is performed repeatedly when the cell phone device 600 is powered on. The timing and the frequency of performing the selecting process according to the disclosure are, however, not limited to these embodiments. One exemplary procedure may monitor the received signal strength indication continuously or at regular intervals and may perform the relay network interface selecting process or the working network interface selecting process when the received signal strength indication has a change of or above a specified level. In this manner, the relay network interface selecting process or the working network interface selecting process may be triggered by any arbitrary event that affects the relay network interface selecting process or the working network interface selecting process, such as a change in received signal strength indication or replacement of the WAN-side IF. The relay network interface selecting process of the first to the third embodiments may be configured to start and terminate one cycle (steps S105 to S125) at predetermined time intervals (e.g., every 100 milliseconds). Similarly the working network interface selecting process of the fourth embodiment may be configured to start and terminate one cycle (steps S105a to S125a) at predetermined time intervals. In another example, the relay network interface selecting process in any of the first to the third embodiments may be triggered by sending data from the personal computer 100 to the Internet NT and receiving a packet including the sent data at the portable network relay device 10 or 10a. In such configuration, for example, when the switching approval/disapproval determination process of the first embodiment determines that switching is disapproved (step S215), the relay network interface selecting process is terminated. This means that the relay network IF is not changed even when the effective TCP session found at step S205 is completed. When it is determined that switching is disapproved (step S215), one modified procedure may refer to the SPI-DB 341 at regular intervals to monitor completion of the effective session found at step S205, determine that switching is approved based on detection of the completion of the session and change the relay network IF to the WAN-side IF newly selected at step S105. Similarly, the working network interface selecting process of the fourth embodiment may be performed during transmission of data from the cell phone device 600 to the Internet INT.

E4. Modification 4

The above embodiments describe the applications of the disclosure to the network relay device (mobile router device) and the cell phone device. The application of the disclosure is, however, not limited to the network relay device or the cell phone device. For example, the disclosure may be applied to any arbitrary network communication device, such as a stationary router device, a portable layer 3 switch or a stationary layer 3 switch.

The SPI-DB or the address conversion table may be stored in a different device other than the network relay device according to the disclosure. For example, a firewall device may be located in the same network segment as the network relay device, and the SPI-DB may be provided in this firewall device. In another example, a gateway device may be located in the same segment as the network relay device, and the address conversion table may be provided in this gateway device. In the modified configuration that the SPI-DB or the address conversion table is provided in a different device other than the network communication device according to the disclosure, the retrieval of the specified TCP session at step S205, S205a or S205b may be performed by inquiring of this different device about the presence or the absence of any specified TCP session. In this configuration, the disclosure may be applied to a network communication system including the network communication device and the different device (e.g., firewall device or gateway device).

E5. Modification 5

The “port number” is stored in the application information storage 343 to identify the “specified protocol” used at step S205a in the switching approval/disapproval determination process of the second embodiment, but the disclosure is not limited to this configuration. For example, a letter string representing the protocol name may be stored, in place of the “port number”, in the application information storage 343. In this modified configuration, the SPI-DB is structured to have a field for recording a letter string representing the protocol name, and the specified TCP session may be searched at step S205a by comparing the registry in this field with the letter string stored in the application information storage 343. In general, an SPI-DB storing any arbitrary information on identification of the protocol used in a logical connection may be employed as the communication database of the network communication device according to the disclosure.

E6. Modification 6

The user's specified protocols are HTTP, RTSP and remote desktop according to the second embodiment, but any protocols used for moving image streaming (video distribution and sound distribution), such as MMS (Microsoft Media Server Protocol) and RTMP (Real Time Messaging Protocol), may be employed in place of or in addition to these protocols. Protocols enabling any arbitrary applications, for example, protocols for file forwarding such as FTP (File Transfer Protocol) and BirTorrent or SMTP (Simple Mail Transfer Protocol) may be employed in place of or in addition to the protocols used for moving image streaming. The user may specify the protocol (application) in which termination of the layer 4 session may lead to the significant disadvantage to the user, such as interruption of the service, in order to prevent termination of the session during execution of the protocol and thereby avoid such disadvantage.

E7. Modification 7

In the above embodiments, the relay network IF is changed to the newly selected WAN-side IF (step S125) as part of the relay network interface selecting process. This step may, however, be performed separately from the relay network interface selecting process. For example, the relay network interface selecting process may be configured to specify the WAN-side IF to be used as the relay network IF and determine the approval or disapproval of switching, and the relay network IF may be actually changed to the specified WAN-side IF only when a further condition is satisfied. Similarly, the step of actually changing the working network interface may be performed separately from the working network interface selecting process.

E8. Modification 8

The configurations of the network relay device 10 or 10a and the cell phone device 600 described in the respective embodiments are only illustrative and may be modified and altered in various ways. For example, the wireless LAN-IF 40 and the wireless WAN-IF 50 or 650 in the respective embodiments may be any wireless communication interface that establishes wireless communication by any future-available wireless LAN, in place of the wireless LAN conforming to IEEE802.11a/b/g/n. The mobile communication IF 60 or 660 may be any wireless communication interface that establishes wireless communication by any future-available mobile communication such as LTE (Long Term Evolution), next-generation mobile WiMax (IEEE802.16m) or next-generation PHS (XGP: eXtended Global Platform), in place of the mobile communication conforming to 3G/HSPA.

Wireless connection using the wireless LAN-IF 40 is employed for connection of the network relay device 10 or 10a with the personal computer 100, but the wireless connection may be replaced with wired connection. In the latter configuration, the network relay device 10 or 10a may be provided with a network interface for wired connection, which is connected with the personal computer 100 by a network cable. The network interface for wired connection may be, for example, a network interface conforming to IEEE802.3ab or IEEE802.3au. Similarly, a network interface for wired connection may be provided as the WAN-side IF, in place of or in addition to the wireless WAN-IF 50 and the mobile communication IF 60.

There are only two WAN-side IFs in the respective embodiments: wireless WAN-IF 50 or 650 and mobile communication IF 60 or 660, but there may be three or more WAN-side IFs. This modified configuration may include a plurality of the same type of network interfaces.

In the respective embodiments, part of the hardware configuration may be replaced by software configuration, while part of the software configuration may be replaced by hardware configuration. In the application that part or all of the functions of the disclosure is implemented by the software configuration, the software (computer programs) may be provided in the form of storage in a computer readable storage medium. The “computer readable storage medium” of the disclosure is not limited to a portable storage medium, such as flexible disk or CD-ROM, but also includes any of internal storage devices in the computer, such as various RAMs and ROMs and external storage devices fixed to the computer, such as hard disk drives. The term “computer readable storage medium” herein is used in the wider sense and includes any non-transitory, fixed storage medium.

### F. Other Aspects

According to one exemplary embodiment, the disclosure is directed to a network communication device. The network communication device comprises a plurality of first network interfaces being respectively connected with different networks and being configured to execute wireless communication or wired communication; a communication controller that send and receive a packet via one of the plurality of first network interfaces; an interface selector that selects one of the plurality of first network interfaces as a candidate interface for a working network interface that is the first network interface used to send and receive the packet, based on a specified first condition; and a switching determiner that determines approval or disapproval of a change of the working network interface from a previously selected network interface to the candidate interface, based on a specified second condition regarding validity of a logical connection via the previously selected network interface, when one of the plurality of first network interfaces different from the previously selected network interface is newly selected as the candidate interface, wherein the previously selected network interface is the current working network interface. When one of the first network interfaces different from the previously selected network interface is newly selected as a candidate interface for the working network interface, the network communication device of this embodiment determines approval or disapproval of a change of the working network interface from the previously selected network interface to the candidate interface, based on the specified second condition regarding the validity of a logical connection via the previously selected network interface. This effectively prevents the working network interface from being changed from the previously selected network interface to the first network interface newly selected as the candidate interface irrespective of the validity of the logical connection, thus preventing interruption of communication using the network communication device accompanied with the change of the working network interface. The change of the working network interface from the previously selected network interface to the candidate interface is determined to be approved by adjusting the second condition. This enables selection of the adequate first network interface satisfying the specified first condition.

According to one aspect of the embodiment, the switching determiner determines that switching is disapproved when the logical connection is valid, while determining that switching is approved when the logical connection is invalid, with referring to a communication database that stores information on identification of the validity of the logical connection. The network communication device of this aspect determines that switching is disapproved when the logical connection via the previously elected network interface is valid, thus prohibiting a change of the working network interface during communication via the logical connection.

According to another aspect, the switching determiner determines, by referring to a communication database that stores information on identification of the validity of the logical connection and information on identification of a protocol used for the logical connection, that switching is disapproved, when the logical connection is valid and the protocol used for the logical connection is a specified protocol, and that switching is approved, when the logical connection is valid and the protocol used for the logical connection is not the specified protocol or when the logical connection is invalid. When the protocol used for the logical connection via the previously selected network interface is the specified protocol, the network communication device of this embodiment prevents interruption of communication using this protocol. Additionally, when the protocol used for the logical connection via the previously selected network interface is not the specified protocol, on the other hand, the network communication device of this embodiment allows a change of the working network interface.

According to another aspect, the specified protocol is a protocol used for video distribution and sound distribution. The network communication device of this aspect prohibits a change of the working network interface during video distribution and sound distribution via the previously selected network interface and thereby prevents interruption of video distribution and sound distribution. Additionally, the network communication device of this aspect allows a change of the working network interface during execution of an application other than video distribution and sound distribution, thus enabling communication via the adequate first network interface satisfying the specified first condition.

According to another aspect, after determining that switching is disapproved, the switching determiner monitors the validity of the logical connection by referring to the communication database and determines that switching is approved when the logical connection becomes invalid. When the logical connection becomes invalid, i.e., when communication via the logical connection is terminated, the network communication device of this aspect allows a change of the working network interface, thus enabling subsequent communication via the adequate first network interface satisfying the specified first condition.

According to another aspect, the logical connection is a session using Transmission Control Protocol (TCP) as a layer 4 protocol in an Open System Interconnection (OSI) reference model. When the session using TCP via the previously selected network interface is valid, the network communication device of this aspect prevents interruption of communication using the session accompanied with a change of the working network interface.

According to another exemplary embodiment, the disclosure is directed to a network communication device. The network communication device comprises a plurality of first network interfaces being respectively connected with different networks and being configured to execute wireless communication or wired communication; a communication controller that send and receive a packet via one of the plurality of first network interfaces; and an interface selector that selects one of the plurality of first network interfaces as a candidate interface for a working network interface that is the first network interface used to send and receive the packet, based on a specified condition, wherein the communication controller sends and receives the packet without changing the working network interface from a previously selected network interface to the candidate interface in case where a logical connection via the previously selected network interface is valid, while sending and receiving the packet with changing the working network interface from the previously selected network interface to the candidate interface in case where the logical connection is invalid, when one of the plurality of first network interfaces different from the previously selected network interface is newly selected as the candidate interface, and the previously selected network interface is the current working network interface. When one of the first network interfaces different from the previously selected network interface is newly selected as a candidate interface for the working network interface, the network communication device of this embodiment relays a packet without changing the working network interface, in case where the logical connection via the previously selected network interface is valid. This effectively prevents interruption of an application using this logical connection accompanied with a change of the working network interface. The network communication device of this embodiment relays a packet with changing the working network interface from the previously selected network interface to the candidate interface, in case where the logical connection via the previously selected network interface is invalid. This enables a packet to be relayed using the adequate first network interface satisfying the specified first condition.

According to one aspect of the embodiment, The network communication device further comprises a second network interface that executes wireless communication or wired communication with a communication terminal, wherein the communication controller relays a packet between the working network interface and the second network interface, and the working network interface is the first network interface that relays the packet to and from the second network interface. The network communication device of this aspect effectively prevents interruption of communication accompanied with a change of the working network interface during relay of data (packet), which is received from a communication terminal via the second network interface, to the first network interface.

According to another exemplary embodiment, the disclosure is directed to a method of selecting a working network interface that is a first network interface used to send and receive a packet in a network communication device that has a plurality of first network interfaces being respectively connected with different networks and being configured to execute wireless communication or wired communication and that uses one of the plurality of first network interfaces to send and receive the packet. The method comprises selecting one of the plurality of first network interfaces as a candidate interface for the working network interface, based on a specified first condition; and determining approval or disapproval of a change of the working network interface from a previously selected network interface to the candidate interface, based on a specified second condition regarding validity of a logical connection via the previously selected network interface, when one of the plurality of first network interfaces different from the previously selected network interface is newly selected as a candidate interface, wherein the previously selected network interface is the current working network interface. When one of the first network interfaces different from the previously selected network interface is newly selected as a candidate interface for the working network interface, the method of this embodiment determines approval or disapproval of a change of the working network interface from the previously selected network interface to the candidate interface, based on the specified second condition regarding the validity of a logical connection via the previously selected network interface. This effectively prevents the working network interface from being changed from the previously selected network interface to the candidate interface irrespective of the validity of the logical connection, thus preventing interruption of communication using the network communication device accompanied with the change of the working network interface. The change of the working network interface from the previously selected network interface to the candidate interface is determined to be approved by adjusting the second condition. This enables selection of the adequate first network interface satisfying the specified first condition.

The disclosure may be implemented by diversity of aspects, for example, a network communication system including a network communication device, a network relay device, a cell phone device, a control method of any of these devices and the system, a computer program configured to implement the functions of any of these devices and the system, and a non-transitory computer-readable storage medium in which such a computer program is recorded.

What is claimed is:

1. A network communication device, comprising:
a plurality of first network interfaces that are respectively connected with different networks and configured to execute wireless communication or wired communication;
a communication controller that controls sending and receiving packets via one of the plurality of first network interfaces;
an interface selector that selects, based on a specified first condition, one of the plurality of first network interfaces as a candidate interface for an active network interface used to send and receive the packets; and
a switching determiner that determines approval or disapproval of a change of the active network interface from a previously selected network interface to the candidate interface, based on a specified second condition regarding validity of a logical connection via the previously selected network interface, when one of the plurality of first network interfaces different from the previously selected network interface is newly selected as the candidate interface and the previously selected network interface is the current active network interface.

2. The network communication device according to claim 1, wherein
the switching determiner determines that switching is disapproved when the logical connection is valid by referring to a communication database that stores information on identification of the validity of the logical connection.

3. The network communication device according to claim 1, wherein
the switching determining determines that switching is approved when the logical connection is invalid by referring to a communication database that stores information on identification of the validity of the logical connection.

4. The network communication device according to claim 1, wherein
the switching determiner determines, by referring to a communication database that stores information on identification of the validity of the logical connection and information on identification of a protocol used for the logical connection, that switching is disapproved when the logical connection is valid and the protocol used for the logical connection is a specified protocol.

5. The network communication device according to claim 1, wherein
the switching determiner determines, by referring to a communication database that stores information on identification of the validity of the logical connection and information on identification of a protocol used for the logical connection, that switching is approved when the logical connection is valid and the protocol used for the logical connection is not the specified protocol or when the logical connection is invalid.

6. The network communication device according to claim 4, wherein
the specified protocol is a protocol used for video distribution and sound distribution.

7. The network communication device according to claim 5, wherein
the specified protocol is a protocol used for video distribution and sound distribution.

8. The network communication device according to claim 2, wherein
after determining that switching is disapproved, the switching determiner monitors the validity of the logical connection by referring to the communication database and determines that switching is approved when the logical connection becomes invalid.

9. The network communication device according to claim 1, wherein
the logical connection is a session using Transmission Control Protocol (TCP) as a layer 4 protocol in an Open System Interconnection (OSI) reference model.

10. A network communication device, comprising:
a plurality of first network interfaces that are respectively connected with different networks and configured to execute wireless communication or wired communication;
a communication controller that controls sending and receiving packets via one of the plurality of first network interfaces; and
an interface selector that selects, based on a specified condition, one of the plurality of first network interfaces as a candidate interface for an active network interface that is the first network interface used to send and receive the packets, wherein
the communication controller controls sending and receiving the packets without changing the active network interface from a previously selected network interface to the candidate interface in case where a logical connection via the previously selected network interface is valid, while controlling sending and receiving the packets by changing the active network interface from the previously selected network interface to the candidate interface in case where the logical connection is invalid, when one of the plurality of first network interfaces different from the previously selected network interface is newly selected as the candidate interface and the previously selected network interface is the current active network interface.

11. The network communication device according to claim 1, further comprising:
a second network interface that executes wireless communication or wired communication with a communication terminal.

12. The network communication device according to claim 11, wherein
the communication controller controls relaying packets between the active network interface and the second network interface.

13. The network communication device according to claim 12, wherein
the active network interface is the first network interface that relays the packets to and from the second network interface.

14. A method of selecting an active network interface that is a first network interface used to send and receive packets in a network communication device that has a plurality of first network interfaces that are respectively connected with different networks and configured to execute wireless communication or wired communication and that uses one of the plurality of first network interfaces to send and receive the packets, the method comprising:
selecting, based on a specified first condition, one of the plurality of first network interfaces as a candidate interface for the active network interface; and
determining approval or disapproval of a change of the active network interface from a previously selected network interface to the candidate interface, based on a specified second condition regarding validity of a logical connection via the previously selected network interface, when one of the plurality of first network interfaces different from the previously selected network interface is newly selected as a candidate interface and the previously selected network interface is the current active network interface.

15. The method according to claim 14, wherein
the determining determines that switching is disapproved when the logical connection is valid by referring to a communication database that stores information on identification of the validity of the logical connection.

16. The method according to claim 14, wherein
the determining determines that switching is approved when the logical connection is invalid by referring to a communication database that stores information on identification of the validity of the logical connection.

17. The method according to claim 14, wherein
the determining determines, by referring to a communication database that stores information on identification of the validity of the logical connection and information on identification of a protocol used for the logical connection, that switching is disapproved when the logical connection is valid and the protocol used for the logical connection is a specified protocol.

18. The method according to claim 14, wherein
the determining determines, by referring to a communication database that stores information on identification of the validity of the logical connection and information on identification of a protocol used for the logical connection, that switching is approved when the logical connection is valid and the protocol used for the logical connection is not the specified protocol or when the logical connection is invalid.

19. The method according to claim 17, wherein
the specified protocol is a protocol used for video distribution and sound distribution.

20. The method according to claim 18, wherein
the specified protocol is a protocol used for video distribution and sound distribution.

21. The method according to claim 15, wherein
after determining that switching is disapproved, the switching monitors the validity of the logical connection by referring to the communication database and determines that switching is approved when the logical connection becomes invalid.

22. The method according to claim 14, wherein
the logical connection is a session using Transmission Control Protocol (TCP) as a layer 4 protocol in an Open System Interconnection (OSI) reference model.
